(19) United States
(12) Patent Application Publication
(10) Pub. No.: US 2024/0311749 A1
(43) Pub. Date: Sep. 19, 2024

(54) ALTERNATIVE NETWORK GENERATION

(71) Applicant: X Development LLC, Mountain View, CA (US)

(72) Inventors: Grace Taixi Brentano, Redwood City, CA (US); Salil Vijaykumar Pradhan, San Jose, CA (US); Rebecca Radkoff, San Francisco, CA (US); David Andre, San Francisco, CA (US); Lam Thanh Nguyen, Mountain View, CA (US); Sze Man Lee, Milpitas, CA (US); Gearoid Murphy, Mountain View, CA (US)

(21) Appl. No.: 18/122,057

(22) Filed: Mar. 15, 2023

(51) Int. Cl. G06Q 10/0835; G06N 3/0475; G06N 3/092; G06N 3/094

(52) U.S. Cl. CPC G06Q 10/08355; G06N 3/0475; G06N 3/092; G06N 3/094

(57) ABSTRACT

Methods, systems, and apparatus, including computer programs encoded on computer storage media, for generating alternative networks. One of the methods includes receiving supply chain data representing a first supply chain network having nodes and links, receiving map data, providing the map data and the supply chain data as input to a generative process that is configured to generate one or more second supply chain networks, receiving, as output from the generative process, a second supply chain network, performing a supply chain simulation on the second supply chain network generated by the generative model, and computing a performance metric for the second supply chain network based on performing the simulation.

### BACKGROUND

This specification relates to generating alternative networks.

Traditional supply chain networks, e.g., networks that move materials between suppliers, factories, warehouses, and retailers, are brittle as well as difficult and expensive to modify. Therefore, small perturbations can lead to serious disruptions and inefficiencies that were not contemplated when the network was set up.

### SUMMARY

This specification relates to techniques for generating supply chain networks that are optimized under certain constraints. Given a first supply chain network and information about the physical environment of the first supply chain network, a second supply chain network can be generated according to the constraints of the environment. The performance of the second supply chain network can be simulated according to environmental conditions.

Particular embodiments of the subject matter described in this specification can be implemented so as to realize one or more of the following advantages.

A generative process receives supply chain data representing a first supply chain network and map data representing locations in a region and transportation routes between the locations. The map data provides a realistic and up-to-date representation of the environment and its constraints to the generative process. Thus the generative process can generate realistic and plausible second supply chain networks that are alternatives to the first supply chain network according to the environment and its constraints.

The types of modifications that can be generated in the second supply chain networks can be defined by a user. The generative process uses a set of operators that define possible modifications to a supply chain network, and a user can define the set of operators. Thus the generative process can generate second supply chain networks with only the types of modifications that the user wants to consider.

A second supply chain network that is an alternative supply chain network to a first supply chain network can have modifications such as additional or removed entities, additional or modified locations, additional or modified materials, additional or modified routes, and additional or modified modes of transportation. The second supply chain network can provide suggestions to the user that have not been implemented, but are feasible to implement under the environment and its constraints.

The performance of second supply chain networks according to certain performance metrics can be simulated to determine which second supply chain networks are optimized under certain conditions. Different second supply chain networks can perform better in different environmental conditions and according to different performance metrics. Thus the simulation provides a user a more thorough understanding of different potential second supply chain networks and the external effects of the second supply chain networks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for generating alternative supply chain networks.

FIG. 2A illustrates a block diagram of an example first supply chain network.

FIG. 2B illustrates a block diagram of an example second supply chain network.

FIG. 2C illustrates a block diagram of an example second supply chain network.

FIG. 3 is a flowchart of a process for generating second supply chain networks.

Like reference numbers and designations in the various drawings indicate like elements.

### DETAILED DESCRIPTION

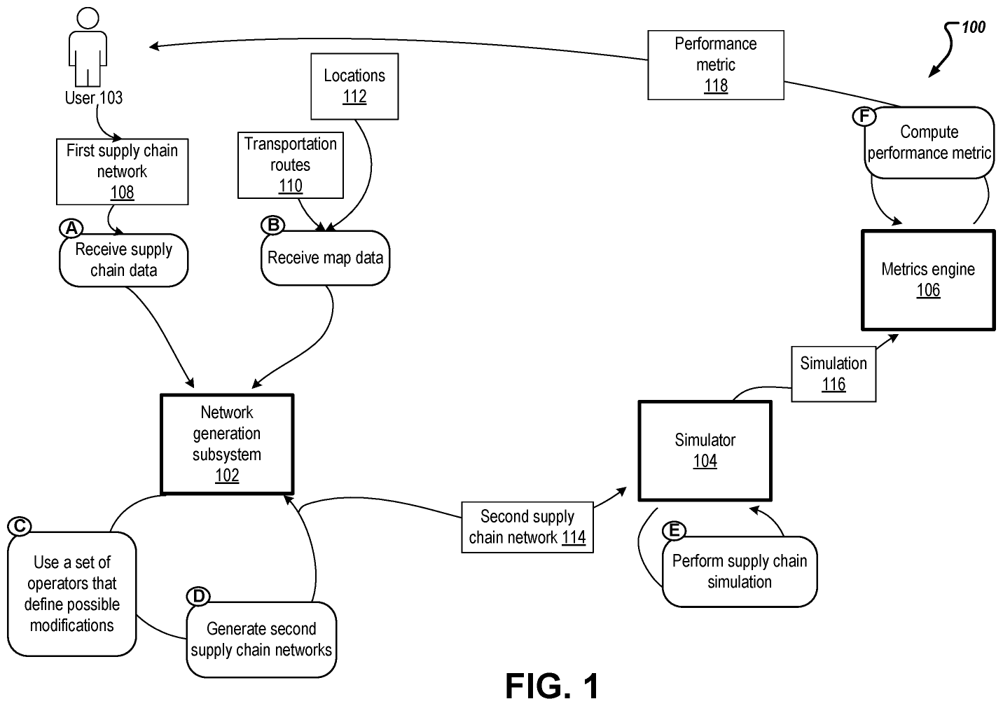

FIG. 1 is a diagram of an example system 100 for generating alternative supply chain networks. The system 100 includes various components, such as a network generation subsystem 102, a user 103, a simulator 104, and a metrics engine 106. In some implementations, the network generation subsystem 102, simulator 104, and metrics engine 106 can be part of a same system and/or network of computing devices and/or systems.

The network generation subsystem 102 can be any type of computing device, computing system, cloud-based system, software, and/or network of computing devices/systems that executes a generative process. The generative process is configured to generate one or more second supply chain networks given supply chain data and map data.

The simulator 104 can be any type of computing device, computing system, cloud-based system, software, and/or network of computing devices/systems that is configured to perform simulations on supply chain networks.

The metrics engine 106 can be any type of computing device, computing system, cloud-based system, software, and/or network of computing devices/systems that is configured to compute a performance metric based on the simulation of the second supply chain network.

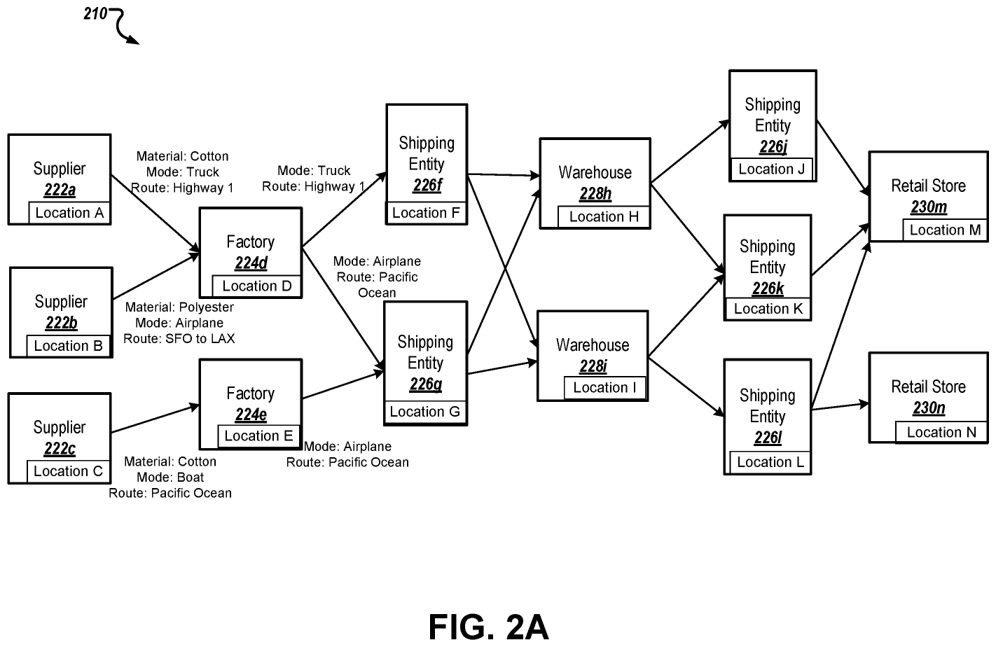

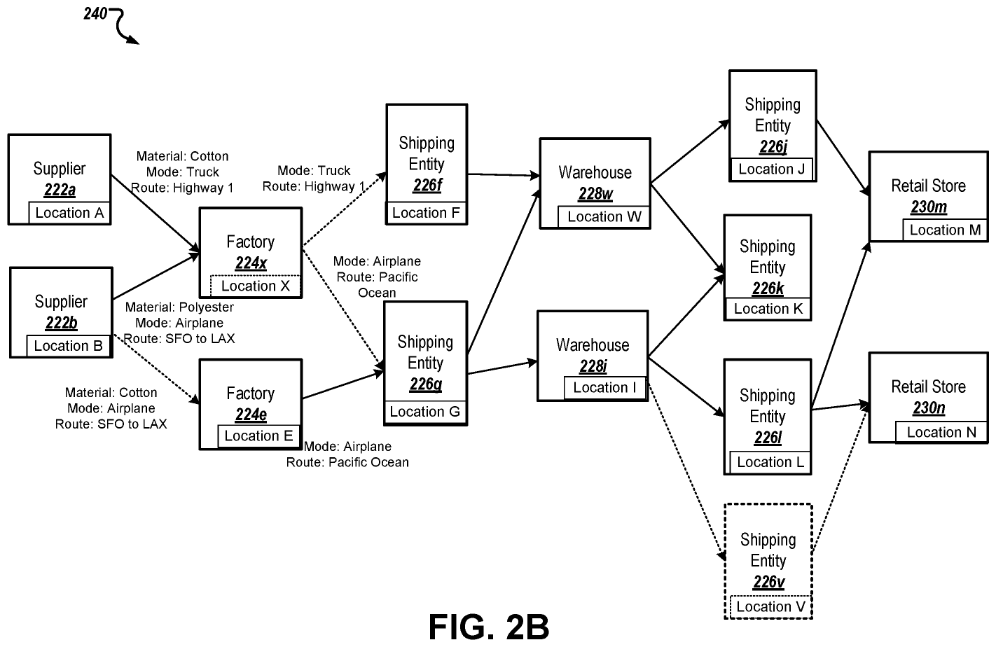

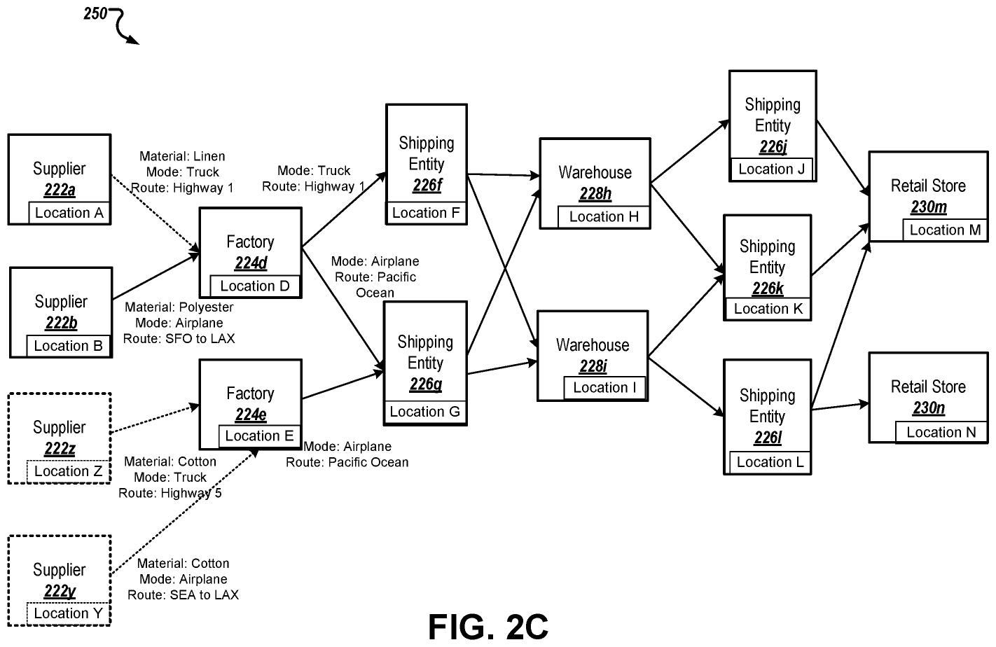

The network generation subsystem 102 that executes the generative process can receive supply chain data in block A. The supply chain data can represent a first supply chain network 108 having nodes and links. Each node can represent an entity involved in producing a product, e.g., suppliers, factories, shipping entities, warehouses, and retailers. In some implementations, a node can represent a business unit that makes high-level decisions and coordinates other nodes. A product can be made of one or more portions that can be produced by different entities, for example, and assembled or combined into the product. Each portion can be made of multiple portions. Each link can represent a portion of a product being transferred between entities, e.g., a portion of a product can be made of a certain material, come from a certain initial location, or be transferred over a certain transportation route or mode of transit. An example of a first supply chain network 108 is shown below in FIG. 2A.

The first supply chain network 108 can be provided by the user 103 (e.g., relevant stakeholder in the supply chain network) through a programming language or natural language interface presented at a computing device such as a user device (e.g., laptop, tablet, mobile phone, smart phone, or computer) of the user 103.

The network generation subsystem 102 that executes the generative process can receive map data in block B. The map data can represent locations 112 in a region and transportation routes 110 between the locations in the region. The region can include the area that the first supply chain network 108 involves, or a larger region that encompasses the area that the first supply chain network 108 involves. The locations 112 can correspond to entities that could be involved in production in the region such as available suppliers, factories, shipping entities, warehouses, and retailers, and the transportation routes 110 can include transportation routes among the suppliers, factories, shipping entities, warehouses, and retailers in the region.

The locations 112 and transportation routes 110 can be provided by external sources. For example, sources may include, but are not limited to, a map database, a business directory, navigation data, flight data, a shipping timetable, and/or ocean freight data.

The network generation subsystem 102 can provide the supply chain data and map data to the generative process executing on the network generation subsystem 102. The generative process can generate one or more second supply chain networks in block D. For example, the second supply chain networks can be alternatives to the first supply chain network 108. The generative process can do so by using a set of operators that define possible modifications in block C. An operator in the set of operators can include adding or deleting a warehouse or factory, adding a new route or a new mode of transit between nodes in the supply chain network, or removing links in the supply chain network. In some implementations, an operator can provide a set of legal constraints or rules within which possible modifications are carried out. In some implementations, at least some of the operators in the set of operators can be provided by the user.

In some implementations, the generative process can use a trained generative machine learning model that takes as input map data and supply chain data and outputs a second supply chain network. In other implementations, the generative process can be implemented using a reinforcement learning model that performs actions that modify the first supply chain network and collects rewards based on values of the performance metric of the supply chain simulation 116.

The generative process can output a second supply chain network 114 to the simulator 104. The second supply chain network 114 can have one or more additional nodes and one or more additional links not represented in the first supply chain network. Examples of second supply chain networks are shown below in FIG. 2B and FIG. 2C.

The simulator 104 can receive the second supply chain network 114 and can perform a supply chain simulation in block E on the second supply chain network 114. A simulation can be used to test how a supply chain performs in certain conditions. For example, conditions can include the current weather and shipping conditions, or the predicted weather and shipping conditions at a future time. Other examples of conditions that can be simulated include natural disasters, including but not limited to snowstorms, hurricanes, tornadoes, or other adverse or unexpected weather patterns. The conditions can also include, but are not limited to, shortages in supply and/or demand for various resources and/or products, employee strikes, employee shortages, other types of labor shortages, traffic and other transport conditions, and other atypical conditions in the operation of a supply chain network. In some implementations, a simulation can include a combination of conditions.

As an illustrative example, sales data, shipping data, data tracking the supply chain of a supplier, data tracking products (e.g., objects) between supplying, production, shipping, and warehousing entities, data tracking products between warehousing entities and consumer-facing entities (e.g., retail stores), and/or demand for at least one consumer-facing entity may be used in performing the supply chain simulation.

The metrics engine 106 can compute a performance metric in block F for the second supply chain network 114 based on performing the simulation 116. For example, a performance metric can measure cost, time, or emissions. A simulation on a particular second supply chain network may reveal that under the conditions of that simulation, the second supply chain network has a high performance metric for cost, but a low performance metric for emissions. Other performance metrics can include average delivery time, delivery costs, monetary costs, labor costs, carbon impact, other environmental costs, worst-case delivery times, 10th percentile-case delivery times, stop-out percentages, and/or estimated lost-revenue amounts.

In some implementations, the system 100 can provide a performance metric 118, the performance metric computed in block F, to the user device of the user 103. For example, the system 100 can transmit data representing the performance metric 118 to the user device for display to the user 103.

In some implementations, the system 100 can also provide information about the second supply chain network 114 and/or the simulation 116 to the user 103. For example, the system 100 can transmit data representing the second supply chain network 114 and data representing the conditions that were tested in the supply chain simulation 116 to the user device of the user 103. The user 103 can review the second supply chain network, the conditions of the simulation, and the performance metric. The user 103 can then determine whether to implement the second supply chain network.

The system 100 can perform the steps in blocks D-F one or more times to test the performance of different second supply chain networks under the same or different conditions according to the same or different performance metrics. In some implementations, the system 100 can perform the steps in blocks D-F one or more times according to a performance metric that the user 103 can define. For example, the user 103 may want to review second supply chain networks under the same or different conditions according to carbon impact.

FIG. 2A illustrates a block diagram of an example first supply chain network 210 that includes nodes and links. The supply chain network 210 can represent a real-world supply chain in which multiple entities interact in the supply chain. The generative process described above in FIG. 1 can receive supply chain data representing the supply chain network 210 and generate second supply chain networks.

As discussed above with reference to FIG. 1, each node can represent an entity involved in producing a product. In the example supply chain network 210, one or more suppliers 222 can supply materials to one or more factories 224. The one or more factories 224 can produce or supply products that can be transported to one or more warehouses 228 via one or more shipping entities 226. The one or more warehouses 228 may also provide the products to one or more retail stores 230 via one or more shipping entities 226. Each entity in the supply chain network 210 can have an associated location A-N that defines where the entity is located. For example, location A can be an address of the supplier 222a.

Each link can represent a portion of a product being transferred between entities, e.g., a portion of a product can be made of a certain material, come from a certain initial location, or be transferred over a certain transportation route or mode of transit. For example, the link from supplier 222a to factory 224d shows that the portion of the product being transferred between them is made of cotton, comes from location A, and is transferred over the route of Highway I using a truck as a mode of transit. As another example, the link from supplier 222b to factory 224d shows that the portion of the product being transferred between them is made of polyester, comes from Location B, and is transferred over the route of San Francisco International Airport to Los Angeles International Airport using an airplane as a mode of transit. The example link from factory 224d to shipping entity 226g shows that a portion of the product is being transferred from Location D by airplane over the Pacific Ocean. Other links in the supply chain network 210 can also have information such as material, initial location, transportation route, and mode of transit.

FIG. 2B illustrates a block diagram of an example second supply chain network 240. The supply chain network 240 can represent a real-world supply chain in which multiple entities interact in the supply chain. The generative process described above in FIG. 1 can generate the second supply chain network 240 from a first supply chain network, for example the first supply chain network 210 of FIG. 2A.

A second supply chain network may have one or more modifications to the links and nodes of the first supply chain network. For example, a second supply chain network can have one or more additional nodes representing one or more locations in the map data not represented in the first supply chain network. A second supply chain network can also have one or more additional links that represent respective transportation routes in the map data not represented in the first supply chain network to one or more preexisting nodes in the first supply chain network. In some implementations, one or more additional links can represent transporting a portion of the product from a different initial location. A second supply chain network can also have removed nodes or links.

Modifications to the first supply chain network 210 of FIG. 2A are shown in dotted lines in the second supply chain network 240 of FIG. 2B. For example in the supply chain network 240, supplier 222c has been removed. There is an additional link from supplier 222b to factory 224e that represents a new material, transportation route, and mode of transit. In addition, factory 224d has been replaced with factory 224x located in location X. Thus the links connecting factory 224x to shipping entity 226f and shipping entity 226g have been modified to show that those links are transporting a portion of the product from a different initial location. The supply chain network 240 also includes an additional shipping entity 226v, an additional link from warehouse 228i to shipping entity 226v, and an additional link from shipping entity 226v to retail store 230n.

The possible effects of these modifications can, for example, be discovered and provided to a user through performing supply chain simulations and computing performance metrics. A system, such as the system 100 of FIG. 1, can perform a supply chain simulation on the second supply chain network 240. For example, the system can use a simulator 104 as described in FIG. 1. The system can compute a performance metric for the second supply chain network 240 based on performing the supply chain simulation. For example, the system can use a metrics engine 106 as described in FIG. 1.

In the example of FIG. 2A, the link from supplier 222c and factory 224e in the first supply chain network 210 shows that cotton is transported from supplier 222c at location C to factory 224e at location E by boat over the Pacific Ocean. In the example of FIG. 2B, removing supplier 222c from the supply chain and adding a link from the existing supplier 222b to factory 224e may affect various performance metrics that can be computed based on performing a supply chain simulation. For example, performing the supply chain simulation can include simulating weather and shipping conditions over the Pacific Ocean. The simulated weather and shipping conditions may make transportation by boat over the Pacific Ocean slow or dangerous. Although the shipping conditions over the Pacific Ocean may have had an effect on the transportation of a portion of a product between supplier 222c and factory 224e, the conditions may not have an effect on the transportation of a portion of a product between existing supplier 222b and factory 224e. Relative to the first supply chain network 210, the second supply chain network 240 may have, for example, a lower cost, shorter delivery time, and/or higher carbon impact.

In the example of FIG. 2A, factory 224d provides a portion of a product to shipping entity 226f. In the example of FIG. 2B, switching from factory 224d to factory 224x may affect various performance metrics that can be computed based on performing a supply chain simulation. For example, performing the supply chain simulation can include simulating weather conditions in location X. The simulated weather conditions may include a natural disaster such as a snowstorm that prevents all modes of transit. The snowstorm may hinder the operations of factory 224x. Relative to the first supply chain network 210, the second supply chain network 240 may have performance metrics that reflect, for example, a shorter delivery time, higher carbon impact, and/or higher labor cost.

In the example of FIG. 2A, a portion of a product gets transported from warehouse 228i to retail store 230n through shipping entity 2261. In the example of FIG. 2B, adding a shipping entity 226v that also transports a portion of the product from warehouse 228i to retail store 230n may affect various performance metrics that can be computed based on performing a supply chain simulation. For example, performing the supply chain simulation can include simulating traffic patterns on routes between warehouse 228i and retail store 230n. The traffic patterns may include a slowdown on the route that shipping entity 2261 takes. The slowdown may increase the delivery time of shipping entity 2261, but may not have an effect on the delivery time of the new shipping entity 226v. Relative to the first supply chain network 210, the second supply chain network 240 may have performance metrics that reflect, for example, a shorter delivery time and/or higher carbon impact.

In some implementations, the simulation can include a combination of conditions, such as weather and shipping conditions over the Pacific Ocean, weather conditions in certain locations, and traffic patterns.

The user can review the second supply chain network 240, the conditions of the simulations, and performance metrics to determine whether to implement the second supply chain network or any of the modifications in the second supply chain network.

FIG. 2C illustrates a block diagram of an example second supply chain network 250. The supply chain network 250 can represent a real-world supply chain in which multiple entities interact in the supply chain. The generative process described above in FIG. 1 can generate the second supply chain network 250 from the first supply chain network, for example the first supply chain network 210 of FIG. 2A.

Modifications to the first supply chain network 210 of FIG. 2A are shown in dotted lines in the second supply chain network 250 of FIG. 2C. For example in the supply chain network 250, supplier 222c has been removed. There are two additional suppliers, supplier 222z and supplier 222y. The link between supplier 222a and factory 224d has also been modified to transport linen instead of cotton in the first supply chain network 210 of FIG. 2A.

In the example of FIG. 2A, the link from supplier 222c and factory 224e in the first supply chain network 210 shows that cotton is transported from supplier 222c at location C to factory 224e at location E by boat over the Pacific Ocean. In the example of FIG. 2C, removing supplier 222c from the supply chain and replacing supplier 222c with supplier 222z and supplier 222y may affect various performance metrics that can be computed based on performing the supply chain simulation. For example, performing the supply chain simulation can include simulating weather and shipping conditions over the Pacific Ocean. The simulated weather and shipping conditions may prevent transportation by boat over the Pacific Ocean. The shipping conditions may not have an effect on the transportation of a portion of a product between suppliers 222z and 222y, and factory 224e. Relative to the first supply chain network 210, the second supply chain network 250 may have performance metrics that reflect, for example, a lower cost and/or shorter delivery time.

In the example of FIG. 2A, supplier 222a supplies factory 224d with cotton. In the example of FIG. 2C, switching from cotton to linen may affect various performance metrics that can be computed based on performing the supply chain simulation. For example, performing a supply chain simulation can also include simulating weather conditions in the region where supplier 222a grows raw material. The simulated weather conditions may be more conducive to growing linen than cotton, making it easier to grow larger amounts of linen than cotton. Relative to the first supply chain network 210, the second supply chain network 250 may have performance metrics that reflect, for example, a lower cost, shorter delivery time, lower carbon impact, and/or higher labor cost.

In some implementations, the simulation can include a combination of conditions, such as weather and shipping conditions over the Pacific Ocean and weather conditions where a supplier grows raw material. The user can review the second supply chain network 250, the conditions of the simulation, and performance metrics to determine whether to implement the second supply chain network or any of the modifications in the second supply chain network.

FIGS. 2A-2C are merely illustrative examples of supply chain networks. There are many potential first supply chain networks, and many second supply chain networks for any given first supply chain network.

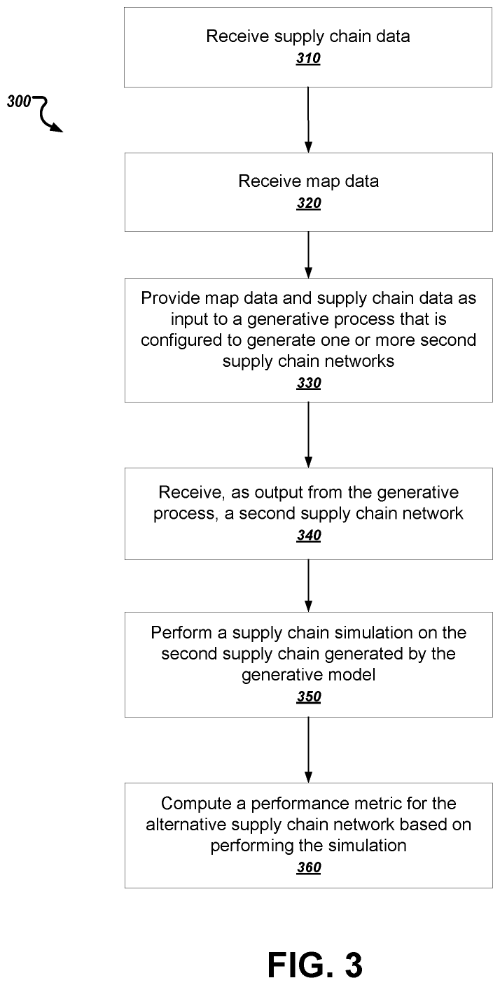

FIG. 3 is a flowchart of a process 300 for generating second supply chain networks, such as in FIGS. 2B-2C. The process 300 can be performed by any appropriate system of one or more computers in one or more locations, e.g., the system 100 of FIG. 1. The system can receive supply chain data (310) representing a first supply chain network having nodes and links. Each node can represent an entity involved in producing a product, and each link can represent a portion of a product being transferred between entities.

The system can receive map data (320) representing locations in a region and transportation routes between the locations in the region.

The system can provide the map data and the supply chain data as input to a generative process that is configured to generate one or more second supply chain networks (330). The generative process can use a set of operators that define possible modifications to an first supply chain network. For example, the set of operators can include adding or deleting a warehouse or a factory, adding a new route or a new mode of transit between nodes in the first supply chain network, or removing links in the first supply chain network. In some implementations, the system can receive at least some of the set of operators from a user.

In some implementations, the generative process can use a trained generative machine learning model, e.g., a generative adversarial network model, that takes as input map data and supply chain data and outputs a second supply chain network. The generative machine learning model can be trained on historical supply chain network data, e.g., as represented by the supply chain data of many other real-world entities. The generative machine learning model can then be trained to generate one or more second supply chain networks that resemble the real-world data. Thus, in some cases the generative machine learning model might generate alternative supply chain modifications that were represented in the supply chain training data of other entities.

Alternatively or in addition, the generative process can be implemented using a reinforcement learning model that performs actions that modify the first supply chain network and collects rewards based on values of the performance metric of the supply chain simulation. The system can thus use the reinforcement learning model to explore and discover more efficient or advantageous supply chain designs.

The system can receive, as output from the generative process, a second supply chain network (340). The second supply chain network can have one or more additional nodes and one or more additional links not represented in the first supply chain network. The one or more additional nodes represent one or more locations in the map data not represented in the first supply chain network, and the one or more additional links can represent respective transportation routes in the map data not represented in the first supply chain network to one or more preexisting nodes in the first supply chain network. In some implementations, the one or more additional links can represent transporting a portion of the product from a different initial location. The one or more additional links can also represent transporting a different material type to be used for a portion of the product. In some implementations, the one or more additional nodes in the second supply chain network can represent a different supplier for a portion of the product than a supplier represented in the first supply chain network.

The system can perform a supply chain simulation on the second supply chain network generated by the generative model (350). Performing the supply chain simulation is discussed in more detail above with reference to FIG. 1.

The system can compute a performance metric for the second supply chain network based on performing the simulation (360). Computing a performance metric is discussed in more detail above with reference to FIG. 1.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
receiving supply chain data representing a first supply chain network having nodes and links, wherein each node represents an entity involved in producing a product, wherein each link represents a portion of a product being transferred between entities;
receiving map data representing locations in a region and transportation routes between the locations in the region;
providing the map data and the supply chain data as input to a generative process that is configured to generate one or more second supply chain networks;
receiving, as output from the generative process, a second supply chain network having one or more additional nodes and one or more additional links not represented in the first supply chain network, wherein the one or more additional nodes represent one or more locations in the map data not represented in the first supply chain network, and wherein the one or more additional links represent respective transportation routes in the map data not represented in the first supply chain network to one or more preexisting nodes in the first supply chain network;
performing a supply chain simulation on the second supply chain network generated by the generative model; and
computing a performance metric for the second supply chain network based on performing the simulation.

Embodiment 2 is the method of embodiment 1, wherein the one or more additional links represent transporting a portion of the product from a different initial location.

Embodiment 3 is the method of any one of embodiments 1-2, wherein the one or more additional links represent transporting a different material type to be used for a portion of the product.

Embodiment 4 is the method of any one of embodiments 1-3, wherein the one or more additional nodes represent a different supplier for a portion of the product than a supplier represented in the first supply chain network.

Embodiment 5 is the method of any one of embodiments I-4, wherein the generative process uses a set of operators that define possible modifications to the first supply chain network.

Embodiment 6 is the method of embodiment 5, wherein the set of operators comprises adding or deleting a warehouse or a factory, adding a new route or a new mode of transit between nodes in the first supply chain network, or removing links in the first supply chain network.

Embodiment 7 is the method of embodiment 5, wherein the method further comprises receiving, from a user, at least some of the set of operators.

Embodiment 8 is the method of any one of embodiments 1-7, wherein the generative process uses a trained generative machine learning model that takes as input map data and supply chain data and outputs a second supply chain network.

Embodiment 9 is the method of any one of embodiments 1-8, wherein the generative process is implemented using a reinforcement learning model that performs actions that modify the input supply chain network and collects rewards based on values of the performance metric of the supply chain simulation.

Embodiment 10 is a system comprising:
one or more computers; and
one or more storage devices storing instructions that are operable, when executed by the one or more computers, to cause the one or more computers to perform operations comprising:
   receiving supply chain data representing a first supply chain network having nodes and links, wherein each node represents an entity involved in producing a product, wherein each link represents a portion of a product being transferred between entities;
   receiving map data representing locations in a region and transportation routes between the locations in the region;
   providing the map data and the supply chain data as input to a generative process that is configured to generate one or more second supply chain networks;
   receiving, as output from the generative process, a second supply chain network having one or more additional nodes and one or more additional links not represented in the first supply chain network, wherein the one or more additional nodes represent one or more locations in the map data not represented in the first supply chain network, and wherein the one or more additional links represent respective transportation routes in the map data not represented in the first supply chain network to one or more preexisting nodes in the first supply chain network;
   performing a supply chain simulation on the second supply chain network generated by the generative model; and
   computing a performance metric for the second supply chain network based on performing the simulation.

Embodiment 11 is the system of embodiment 10, wherein the one or more additional links represent transporting a portion of the product from a different initial location.

Embodiment 12 is the system of any one of embodiments 10-11, wherein the one or more additional links represent transporting a different material type to be used for a portion of the product.

Embodiment 13 is the system of any one of embodiments 10-12, wherein the one or more additional nodes represent a different supplier for a portion of the product than a supplier represented in the first supply chain network.

Embodiment 14 is the system of any one of embodiments 10-13, wherein the generative process uses a set of operators that define possible modifications to the first supply chain network.

Embodiment 15 is the system of embodiment 14, wherein the set of operators comprises adding or deleting a warehouse or a factory, adding a new route or a new mode of transit between nodes in the first supply chain network, or removing links in the first supply chain network.

Embodiment 16 is the system of embodiment 14, wherein the operations further comprise receiving, from a user, at least some of the set of operators.

Embodiment 17 is the system of any one of embodiments 10-16, wherein the generative process uses a trained generative machine learning model that takes as input map data and supply chain data and outputs a second supply chain network.

Embodiment 18 is the system of any one of embodiments 10-17, wherein the generative process is implemented using a reinforcement learning model that performs actions that modify the input supply chain network and collects rewards based on values of the performance metric of the supply chain simulation.

Embodiment 19 is a computer storage medium encoded with a computer program, the program comprising instructions that are operable, when executed by data processing apparatus, to cause the data processing apparatus to perform operations comprising:
receiving supply chain data representing a first supply chain network having nodes and links, wherein each node represents an entity involved in producing a product, wherein each link represents a portion of a product being transferred between entities;
receiving map data representing locations in a region and transportation routes between the locations in the region;
providing the map data and the supply chain data as input to a generative process that is configured to generate one or more second supply chain networks;
receiving, as output from the generative process, a second supply chain network having one or more additional nodes and one or more additional links not represented in the first supply chain network, wherein the one or more additional nodes represent one or more locations in the map data not represented in the first supply chain network, and wherein the one or more additional links represent respective transportation routes in the map data not represented in the first supply chain network to one or more preexisting nodes in the first supply chain network;
performing a supply chain simulation on the second supply chain network generated by the generative model; and
computing a performance metric for the second supply chain network based on performing the simulation.

Embodiment 20 is the computer storage medium of embodiment 19, wherein the one or more additional links represent transporting a portion of the product from a different initial location.

Embodiment 21 is a computer storage medium encoded with a computer program, the program comprising instructions that are operable, when executed by data processing apparatus, to cause the data processing apparatus to perform the method of any one of embodiments 1 to 9.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving supply chain data representing a first supply chain network having nodes and links, wherein each node represents an entity involved in producing a product, wherein each link represents a portion of a product being transferred between entities;
receiving map data representing locations in a region and transportation routes between the locations in the region;
providing the map data and the supply chain data as input to a generative process that is configured to generate one or more second supply chain networks;
receiving, as output from the generative process, a second supply chain network having one or more additional nodes and one or more additional links not represented in the first supply chain network, wherein the one or more additional nodes represent one or more locations in the map data not represented in the first supply chain network, and wherein the one or more additional links represent respective transportation routes in the map data not represented in the first supply chain network to one or more preexisting nodes in the first supply chain network;
performing a supply chain simulation on the second supply chain network generated by the generative model; and
computing a performance metric for the second supply chain network based on performing the simulation.

2. The method of claim 1, wherein the one or more additional links represent transporting a portion of the product from a different initial location.

3. The method of claim 1, wherein the one or more additional links represent transporting a different material type to be used for a portion of the product.

4. The method of claim 1, wherein the one or more additional nodes represent a different supplier for a portion of the product than a supplier represented in the first supply chain network.

5. The method of claim 1, wherein the generative process uses a set of operators that define possible modifications to the first supply chain network.

6. The method of claim 5, wherein the set of operators comprises adding or deleting a warehouse or a factory, adding a new route or a new mode of transit between nodes in the first supply chain network, or removing links in the first supply chain network.

7. The method of claim 5, wherein the method further comprises receiving, from a user, at least some of the set of operators.

8. The method of claim 1, wherein the generative process uses a trained generative machine learning model that takes as input map data and supply chain data and outputs a second supply chain network.

9. The method of claim 1, wherein the generative process is implemented using a reinforcement learning model that performs actions that modify the input supply chain network and collects rewards based on values of the performance metric of the supply chain simulation.

10. A system comprising:
one or more computers; and
one or more storage devices storing instructions that are operable, when executed by the one or more computers, to cause the one or more computers to perform operations comprising:
receiving supply chain data representing a first supply chain network having nodes and links, wherein each node represents an entity involved in producing a product, wherein each link represents a portion of a product being transferred between entities;
receiving map data representing locations in a region and transportation routes between the locations in the region;
providing the map data and the supply chain data as input to a generative process that is configured to generate one or more second supply chain networks;
receiving, as output from the generative process, a second supply chain network having one or more additional nodes and one or more additional links not represented in the first supply chain network, wherein the one or more additional nodes represent one or more locations in the map data not represented in the first supply chain network, and wherein the one or more additional links represent respective transportation routes in the map data not represented in the first supply chain network to one or more preexisting nodes in the first supply chain network;
performing a supply chain simulation on the second supply chain network generated by the generative model; and
computing a performance metric for the second supply chain network based on performing the simulation.

11. The system of claim 10, wherein the one or more additional links represent transporting a portion of the product from a different initial location.

12. The system of claim 10, wherein the one or more additional links represent transporting a different material type to be used for a portion of the product.

13. The system of claim 10, wherein the one or more additional nodes represent a different supplier for a portion of the product than a supplier represented in the first supply chain network.

14. The system of claim 10, wherein the generative process uses a set of operators that define possible modifications to the first supply chain network.

15. The system of claim 14, wherein the set of operators comprises adding or deleting a warehouse or a factory, adding a new route or a new mode of transit between nodes in the first supply chain network, or removing links in the first supply chain network.

16. The system of claim 14, wherein the operations further comprise receiving, from a user, at least some of the set of operators.

17. The system of claim 10, wherein the generative process uses a trained generative machine learning model that takes as input map data and supply chain data and outputs a second supply chain network.

18. The system of claim 10, wherein the generative process is implemented using a reinforcement learning model that performs actions that modify the input supply chain network and collects rewards based on values of the performance metric of the supply chain simulation.

19. A computer storage medium encoded with a computer program, the program comprising instructions that are operable, when executed by data processing apparatus, to cause the data processing apparatus to perform operations comprising:
receiving supply chain data representing a first supply chain network having nodes and links, wherein each node represents an entity involved in producing a product, wherein each link represents a portion of a product being transferred between entities;
receiving map data representing locations in a region and transportation routes between the locations in the region;
providing the map data and the supply chain data as input to a generative process that is configured to generate one or more second supply chain networks;
receiving, as output from the generative process, a second supply chain network having one or more additional nodes and one or more additional links not represented in the first supply chain network, wherein the one or more additional nodes represent one or more locations in the map data not represented in the first supply chain network, and wherein the one or more additional links represent respective transportation routes in the map data not represented in the first supply chain network to one or more preexisting nodes in the first supply chain network;
performing a supply chain simulation on the second supply chain network generated by the generative model; and
computing a performance metric for the second supply chain network based on performing the simulation.

20. The computer storage medium of claim 19, wherein the one or more additional links represent transporting a portion of the product from a different initial location.
